(19) United States
(12) Patent Application Publication
(10) Pub. No.: US 2011/0023374 A1
(43) Pub. Date: Feb. 3, 2011

(54) STATIONARY ACTUATING DEVICE TO OPERATE STATIONARY COKE OVEN DOORS

(75) Inventors: Franz-Josef Schuecker, Castrop-Rauxel (DE); Peter Thomas, Erkelenz (DE)

Correspondence Address: MARSHALL & MELHORN, LLC, FOUR SEAGATE - EIGHTH FLOOR, TOLEDO, OH, 43604, US

(73) Assignee: UHDE GMBH, Dortmund (DE)

(21) Appl. No.: 12/734,838

(22) PCT Filed: Nov. 13, 2008
(86) PCT No.: PCT/EP2008/009564

§ 371 Date: Oct. 13, 2010

(30) Foreign Application Priority Data
Nov. 27, 2007 (DE) 10 2007 057 412.8

(51) Int. Cl. C10B 25/14; E05F 15/18

(52) U.S. Cl. 49/506; 202/248

(57) ABSTRACT

The present invention relates to a drive mechanism for vertical opening and closing of coke oven doors of horizontal coke oven chambers. The doors are lifted via a chain or a rope into the opened position. The rope or the chain is linked via deflector rollers to an actuating lever. The rope or chain can be pulled horizontally so that the doors are pulled-up vertically via the deflector rollers. The actuating lever is linked to a pull eye which upon actuation of the actuating lever can engage into the gripping cam of a gripping car. The gripping car is driven by a rope tackle and upon actuation of the actuating lever it pulls the door into the opened position. The door can be arrested via a suitable mechanism in its opened position.

The present invention relates to a transmission device for a traction force for vertical opening and closing of stationary coke oven doors of horizontal coke oven chambers. The device is capable of approaching the doors of individual ovens, arresting them in open position and moving them back into the closed position upon the end of a charging or cleaning procedure which the door is opened for. The device is also comprised of an object that generates the traction force needed for opening and transfers it to the oven doors to be opened. The device is also comprised of a control unit by which the moment of opening and the duration of opening of oven doors can be controlled. Finally the present invention also relates to a method which approaches the oven doors and opens or closes them depending on demand.

In a modern coke plant operation, pushing of a coke cake from an oven chamber is realized by a coke pusher machine from a front side of the coke oven and through it. On the opposite side of the oven there also is a door which is opened for the coke pushing procedure. The actual coke pushing procedure is realized by the aid of a pusher bar by way of which the coke cake is pushed into a coke quenching car arranged on the opposite side. As a rule, doors are opened only for the duration of coke pushing and for a cleaning procedure carried-out on demand. Upon completion of these procedures, the doors are closed as rapidly as possible to keep the heat loss of the coke oven battery as low as possible. For this reason, a reliable door moving mechanism must be available for the coke pushing procedure and for the work associated therewith.

Various designs of doors and door locking mechanisms are available for closing of coke oven doors. For so-called “conventional” coke ovens which separate gaseous and vaporous carbonization products during the carbonization process that are further processed in so-called “by-product plants”, mobile oven chamber doors are frequently used. Coal charging and coke pushing machines provided with special door lifting devices and extracting the door completely from the coke oven door opening envisaged for this purpose are utilized for charging and discharging a coke oven. It affords good access to the openings which in general are polluted after a carbonization cycle due to deposits and contaminants originating from the carbonization process. Since a cleaning to the benefit of an optimal coke oven sealing is indispensable, this design is frequently implemented for “conventional” coke ovens operating in regular carbonization cycles.

So-called “Heat Recovery” or “Non-Recovery” coke ovens which utilize gaseous and vaporous carbonization products evolving from the carbonization process for combustion and thus for the process heat mostly employ stationary door lifting devices mounted individually at each coke oven door. Since there are no by-products generated by combustion in a “Heat Recovery” coke oven type, a cleaning process calling for substantial space is not required in regular operation. For example, the door lifting devices can be operated by a rope tackle or by chains equipped with a hydraulic drive. Closing of the door is then realized by gravity force. It is also feasible to operate the door lifting devices by independent door lifting devices which are moved for the opening process to the oven chamber to be operated.

The German patent DE 2720469 A1 describes a lifting device for oven chamber doors of a coke oven which registers the directions of movement of the door in outbound direction and lowering movement by counters so that it is possible to extract the coke oven door from the opening and to re-install the door exactly after the cleaning procedure. The doors are supported on a cart which accommodates the door device and can move the entire door device on rollers and rails away from the oven opening and back to it again. Hydraulic cylinders which can move the door both alongside the coke oven and vertically to it serve as drive devices. Transmission of forces is realized via linkages. This configuration in which the entire oven door device is moved away from the oven is particularly suitable for “conventional” coke ovens.

EP 1373435 A1 describes a device for lifting-off stationary-mounted oven doors of a coke oven. The device described therein teaches an actuating mechanism for doors and door frames of coke oven doors. Connected next to the door or coke oven door frame is a door lifting head which is comprised of a driving device for actuation movements and a suction hood. To avoid emissions of carbonization products during coal carbonization, sealing elements are mounted at the door lifting head which provide a suction space for door emissions when opening the coke oven door. The doors are moved via stationary driving devices. This arrangement is particularly suitable for “Heat Recovery” coke ovens.

The systems described therein fulfil their tasks with regard to positioning and movement of coke oven doors. However, they are afflicted with some drawbacks, because they call for substantial space or they require time-devouring door extracting procedures. A door extractor implemented on a coke oven service machine involves a prolongation in the cycle time of carbonization cycles because they can only be utilized if the machine is properly positioned at the coke oven. Door lifting machines approaching the individual coke ovens for opening and closing require space to move between the oven front wall and the oven service machine, a space which must be provided on construction and operation, and these machine tie-up personnel for operation and maintenance of the equipment. Stationary door lifting machines call for an installation of moving equipment in the entrance zone of coke oven doors, thus entailing a high demand for space and installation.

Now, therefore, it is the object of the present invention to provide a mechanism that can reliably handle and operate door locking devices of coke oven batteries. The door locking device should require little space and involve small expenditure on installation. The maintenance of the door locking device should be as simple as possible and allow for an individual approach to the individual coke ovens. Moreover, the door moving mechanism should be suitable for various door types and as little sensitive as possible to contamination and dirt.

The present invention solves the object by a device in which a rope or chain can exert or relieve a horizontal traction force and transmit it via deflector rollers to the individual doors in vertical direction. In horizontal direction, the ropes are connected at the end with a pull eye. The horizontal traction force is rendered via a gripping car sitting on a rail above the coke ovens and travelling along the coke oven walls. The gripping car is driven via a rope winch located at the outset of the coke oven battery. The individual coke oven doors are approached via a traction cam arranged at the lower bottom of the gripping car which engages into the pull eye at the end of the rope depending on its controlled approach. The pull eye can be hooked by a manually or automatically operated device into the traction cam of the gripping car.

Moreover, the device is comprised of a measuring device to record the rope traction force, with said device being combined with a measuring device to measure the gripping car travelling path. Not until the value of the rope traction force has reached a given set point value commences the path measurement for the gripping car. A control system calculates the optimum stopping position for the gripping car based on the door weight, the gripping car position, and the rope traction force so that the doors will always have the proper opening level required for the charging and cleaning cycle. Thereby, the door can constantly be moved to the same level on opening even if the rope length or rope tension differs.

The inventive device is suitable both for “Heat Recovery” coke ovens, “Non-Recovery” coke ovens and “conventional” coke ovens. If utilized for conventional coke ovens, however, one will have to reckon with an intensified propensity to pollution. For this reason, the inventive device may also be comprised of structures designed to prevent deposits and encrustation.

Claimed in particular is a device for closing of horizontal coke oven chambers of an oven bank or oven battery, wherein
the oven walls are installed at one side or at both sides of the horizontally arranged oven walls, and
the oven doors are linked to a rope or a chain or a pulling device by means of which the doors can be pulled out towards the top from the closed into the opened position and be moved again by gravity force into the closed position,
   characterized in that
deflector rollers are arranged above the individual oven doors by means of which the traction force serving for pulling the ropes or chains is directed via these deflector rollers into a direction thus runs horizontally in the further course of said ropes or chains, and wherein a fixing device or an actuating lever including a pull eye are arranged at the end of the rope, and
at least one gripping car is sitting above the oven door in a rail to be able to move said gripping car with a bilaterally arranged rope tackle in horizontal direction in parallel to the series of the coke oven battery walls encompassing the door, and
the fixing device or the actuating lever including the pull eye at the end of the rope above the individual coke oven doors and thereby the rope engages into a downwardly directed cam mounted on the gripping car so that the rope is pulled or relieved and the coke oven door can be pulled up or let down with the horizontal movement of the gripping car.

To allow for a controlled approach to the individual coke oven batteries, a gripping cam is installed under the gripping car which engages into the pull eye to enable an individual approach to the individual coke ovens. The pull eye is fastened to an actuating lever and is snapped-in via suitable press-on pins into the gripping cam. This kind of a control system is usually necessary. The inventive device can also be equipped with one gripping car or several gripping cars on the rail located above the coke oven door. Merely in case there is only one horizontal coke oven chamber in the coke oven battery, one can dispense with a control system comprised of press-on pins and actuating levers, and one can actuate the door opening mechanism by the aid of merely one gripping car and one pull eye.

The press-on pins can be moved both electromagnetically, by an actuator motor or even manually. In an approach cycle, the press-on pins are so arranged that they press the pull eye into the gripping cam of the car and let it be pulled along by the rope tackle linked to the door.

One actuating device including pull eye and one press-on pin are provided for each individual coke oven. The press-on pins are preferably located on the travel rail of the gripping car which extends alongside the door-side oven walls. However, the press-on pins can be arbitrarily positioned to allow for a snapping-in of the pull eye into the gripping cam. Even the driving mechanism for moving the press-on pins can be arbitrarily configured inasmuch as it ensures a response of the actuating lever and thus an engagement of the pull eye into the gripping cam.

The press-on pins are preferably seated on the rail which is comprised of the deflecting device for the rope tackles and which is located underneath the guide rail for the gripping car. Thus, it is not necessary to install an additional holding device for the press-on pins. For example, it is possible to configure the press-on device as a thickening of the suspension rail which is exactly positioned at the correct position to activate the actuating lever.

To execute the charging and cleaning procedure, it is purposive to position the doors for all coke oven batteries at the same level. The cleaning procedure can thus be standardized and the structures required for this purpose are better to install. The different weight of doors and the partly differing rope length or rope tension of the traction rope must be considered to this effect. Different rope lengths or different rope elongation can thereby be compensated for.

According to the present invention, this is achieved by the fact that the rope traction device or the rope tackle is comprised of a rope traction force measurement and that the gripping car is equipped with a position measurement. Thereby, the gripping car can stop exactly at the position that is required to ensure an optimum positioning or level of the door opening device. The starting position of the gripping car is determined by the rope traction force that is available when reaching a certain percentage of the door weight. Preferably the rope traction force is so adjusted and set that the starting position of the gripping car is reached at a percentage of 80 per cent of the total door weight.

The drive of the gripping car is advantageously realized by a rope winch located at the end of the coke oven battery at a central position. Thereby, one rope traction drive device is sufficient for all coke oven doors. The rope winch can be driven by arbitrary devices. Examples of such drives are electric motors, combustion engines or hydraulic facilities. Finally, the traction rope can also be driven by a gear drive instead of a rope winch, for example if the traction rope is a chain that can engage into the holding teeth of a gear. As a matter of fact, even several gripping cars can be moved on the rail located above the coke oven door depending on each other or independently of each other. Finally, all devices enabling the traction or traction relief drive of a rope are suitable.

To configure the traction load of the traction rope in the opened door position not too high, an arresting device is preferably installed at the door which can keep the door in its opened position. Upon opening the door, it is snapped-in so that the door can be arrested via the arrest stop in the opened position. For example, the arresting device may be a latch, an eye or a hinge. However, the arresting device can be of an arbitrary configuration to achieve its arresting or holding in the opened position.

The coke oven doors can be of an arbitrary configuration in order to allow them to be opened with the inventive device. In this way, it is possible to support the door in rails or on a hinge. During opening, the doors are guided within the rails or guided via the hinge into the opened position. Even the number of doors may be arbitrary. For example, it is possible to equip two doors per oven with doors that are provided with the inventive opening device. It is also possible to equip two doors per oven with doors whereof only one is provided with the inventive opening device.

Finally also claimed is a method for operating a coke oven battery characterized in that
the press-on pin and thereby the actuating lever is actuated for a certain coke oven when activating the door opening mechanism, and
the gripping car with the gripping cam is moved by a rope tackle via the actuating lever with the pull eye, and
the pull eye snaps-in and the chains and ropes connected thereto are tightened by the gripping car, thus opening the coke oven door, and
the coke oven door snaps-in behind the press-on pins in closed position, and
the actuating lever is again released by deactivating the press-on pins for closing the coke oven doors.

By means of this drive mechanism, the oven doors of a coke oven can be opened and closed. The door openings are preferably controlled in terms of time in such a way that the carbonization schedule can be optimally set and the carbonization cycles as well as cleaning procedures can be optimally controlled and regulated. By a time-related correct actuation of the press-on pins, the gripping car can engage into the pull eye exactly at the required moment and thereby actuate the traction mechanism.

The time-related controlled approach to the individual coke oven doors can be realized both manually and in automatic mode, with it well being possible to use an electronic control in the latter case. Especially suitable for this purpose is a so-called programmable logical control (PLC) by means of which a precisely controlled carbonization schedule can be set-up. This control can also be realized via a computerized process control system. Depending on the pulse setting of this system, the press-on mechanisms are so actuated that the gripping car can move into the appropriate position and the pull eye can move into the gripping cam of the gripping car.

The inventive device is elucidated by way of three drawings, with these drawings just representing examples of embodiments for the design of the inventive device.

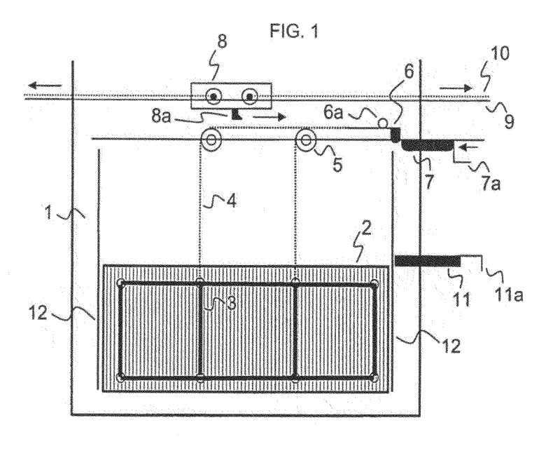

FIG. 1 shows a closed coke oven door with an inventive device for opening and closing this coke oven door. A coke oven (1) is closed by a coke oven door (2) which is linked via a holding device (3) or a holding frame to ropes (4) or chains for suspension. By lifting this chain, the door (2) is raised into the opened position. Deflector rollers (5) deflect this vertical traction into a horizontal direction. At its end side, the chain is linked to an actuating lever (6) which a pull eye (6a) is fastened to. This actuating lever (6) is actuated via a press-on pin (7). The press-on pin (7) is sitting on the rail on which the deflector rollers (5), too, are fastened to. For example, this actuating pin can be actuated via a lever (7a) or an automatically driven device. Situated above the actuating lever is a gripping car (8) which rests on a rail (9). This gripping car (8) is provided with a gripping cam (8a) that can engage into the pull eye (6a). The gripping car is driven via a rope tackle or a rope winch (10). Arranged at the door is an arresting mechanism (11) by means of which the door can be arrested via a lever or an automatic device (11a) in its opened position.

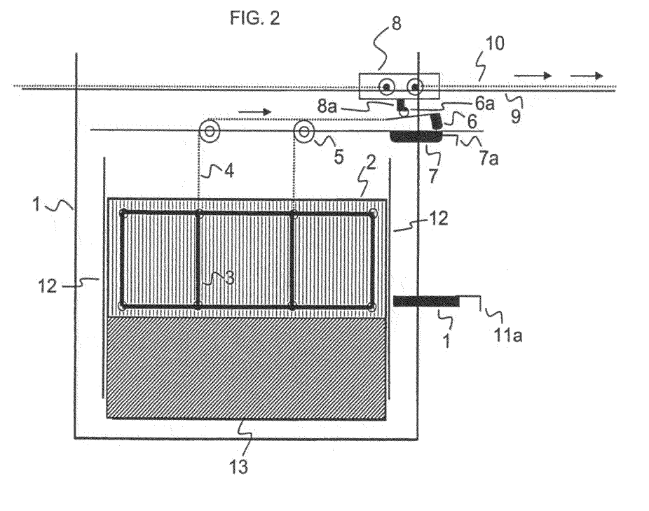

FIG. 2 shows a coke oven door provided with an inventive device which is pulled for opening at the chain (4) with a gripping car (8) at the pull eye (6a) into the opened position. To this effect the actuating lever (6) is moved via the press-on pin at the rail (7) into a positioned inclined hereto.

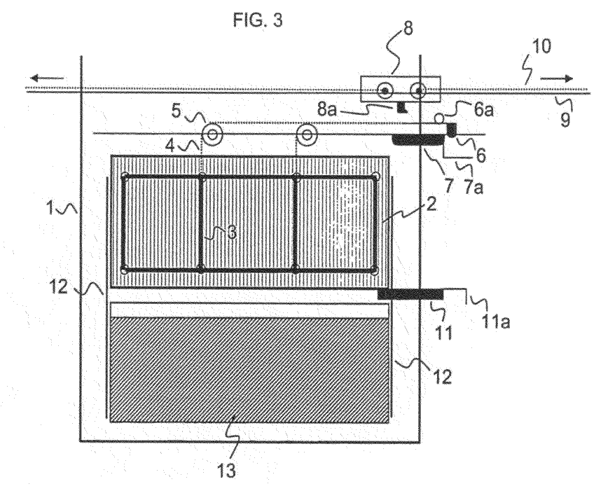

FIG. 3 shows a coke oven door (2) in its opened position. The gripping car (8) actuated via the rope tackle (10) has lifted the door into the opened position. The actuating lever (6) has been moved to behind the press-on pin (7) so that the gripping car (8) can pass by the pull eye (6a). The door (2) is additionally arrested via the arresting mechanism (11) in the opened position.

### LIST OF REFERENCE SYMBOLS

1 Coke oven
2 Coke oven door
3 Holding device for coke oven door
4 Rope tackle or chain
5 Deflector roller
6 Actuating mechanism

### 6a Pull eye

### 7 Press-on pin

7a Lever for press-on pin

### 8 Gripping car

### 8a Pull eye

9 Guide rail
10 Rope tackle for gripping car
11 Arresting mechanism
11a Lever for arresting mechanism
12 Guide rail for coke oven door
13 Coke cake

1-14. (canceled)

15. A device for closing of horizontal coke oven chambers of an oven bank or oven battery by means of coke oven doors closing in vertical direction, wherein
the oven doors are installed at one side or at both sides of the horizontally arranged oven walls, and
the oven doors are linked to a rope or a chain or a pulling device by means of which the doors can be pulled out towards the top from the closed into the opened position and be moved again by gravity force into the closed position,
above the individual oven doors there are deflector rollers by means of which the traction force serving for pulling the ropes or chains is directed via these deflector rollers into a horizontal direction in the further course of the said ropes or chains and wherein a fastening or an actuating lever with a pull eye is situated at the end of the rope, wherein
at least one gripping car is sitting above the oven door in a rail to be able to move said gripping car with a bilaterally arranged rope tackle in horizontal direction in parallel to the series of the coke oven battery walls encompassing the door, and
the fixing device or the actuating lever including the pull eye at the end of the rope above the individual coke oven doors and thereby the rope engages into a downwardly directed cam mounted on the gripping car so that the rope is pulled or relieved and the coke oven door can be pulled up or let down with the horizontal movement of the gripping car.

16. The device as claimed in claim 15, wherein press-on pins are mounted at a rail located under the gripping car through which the actuating device is activated and the pull eye connected to the actuating lever on at least one coke oven door is moved into a position suitable for engaging or disengaging the cam of the gripping car.

17. The device as claimed in claim 15, wherein the press-on pins are located in the travel rail located alongside the door-side oven walls and can be so positioned that the actuating lever and thus the pull eye and the oven door can be moved thereby.

18. The device as claimed in claim 15, wherein the press-on pins are applied in form of a thickening at the lower rail, said thickening having a length that releases the actuating mechanism and the pull eye connected therewith exactly upon setting down the oven door into the open or closed position.

19. The device as claimed in claim 15, wherein the rope for pulling the gripping car runs over the entire oven battery and is pulled as well as relieved by a rope pulley drive for all coke oven doors.

20. The device as claimed in claim 15, wherein the rope tackles or rope winch or gripping car are equipped with a rope traction force measurement and that the gripping car is equipped with a position pickup so that the gripping car can be positioned when tightening the rope depending on the rope length and rope elongation.

21. The device as claimed in claim 20, wherein the starting position of the gripping car is located where the traction force accounts for 80 percent of the weight of the door to be pulled.

22. The device as claimed in claim 16, wherein the actuating pins for pressing-in the pull eyes are actuated via a manual mechanism.

23. The device as claimed in claim 15, wherein the actuating pins for pressing-in the pull eyes are actuated via an electromagnetic mechanism.

24. The device as claimed in claim 15, wherein a tensioning device is situated at the oven which arrests the oven door in its opened position.

25. A method for operating a coke oven battery as defined in claim 15, wherein
the press-on pin and thereby the actuating lever is actuated for a certain coke oven when activating the door opening mechanism, and
the gripping car with the gripping cam is moved by a rope tackle via the actuating lever with the pull eye, and
the pull eye snaps-in and the chains and ropes connected thereto are tightened by the gripping car, thus opening the coke oven door, and
the coke oven door snaps-in behind the press-on pins in closed position, and
the actuating lever is again released by deactivating the press-on pins for closing the coke oven doors.

26. The method as claimed in claim 25, wherein the press-on pins are activated via a manual mechanism.

27. The method as claimed in claim 25, wherein the press-on pins are activated via an electro-magnetic mechanism.

28. The method as claimed in claim 27, wherein the electro-magnetic mechanism is actuated via a programmable logical control.
